(19) United States
(12) Patent Application Publication
(10) Pub. No.: US 2007/0070274 A1
(43) Pub. Date: Mar. 29, 2007

(54) Transflective liquid crystal display having electrically connected reflective electrodes

(75) Inventors: Guo-Hua Yu, Shezhen (CN); Yu-Hsun Jen, Miao-Li (TW)

Correspondence Address: WEI TE CHUNG;FOXCONN INTERNATIONAL, INC., 1650 MEMOREX DRIVE, SANTA CLARA, CA, 95050, US

(73) Assignee: INNOLUX DISPLAY CORP.

(21) Appl. No.: 11/526,534

(22) Filed: Sep. 25, 2006

(30) Foreign Application Priority Data
Sep. 23, 2005 (TW) 94216416

(51) Int. Cl. G02F 1/1335

(52) U.S. Cl. 349/114

(57) ABSTRACT

A transflective liquid crystal display (200) has a first substrate (210), a second substrate (220) opposite to the first substrate; a liquid crystal layer (230) sandwiched between the first and the second substrates; and a plurality of pixel units defined at the second substrate. Each pixel unit has a pixel electrode (224) and a reflective electrode (241), and the reflective electrodes of at least two adjacent of the plurality of pixel units are electrically connected together.

### BACKGROUND OF THE INVENTION

1. Field of the Invention

The present invention relates to transflective liquid crystal displays (LCDs), and particularly to a transflective LCD having electrically connected reflective electrodes.

2. General Background

Cathode Ray Tubes (CRTs), Electroluminescence (EL) displays, Plasma Display Panels (PDPs) etc. are all light emissive type displays that are in widespread use. The display contents of these displays can be overwritten electrically

All of these types of displays generate tiny beams of light, which are collectively used to provide images for a display screen of the display. Therefore these types of displays have high power consumption. Further, a light-emitting surface in each of these types of displays serves as a display surface having high reflectance. Therefore if the display is used under conditions where ambient light is brighter than the luminance of the display screen (for example, in direct sunlight), then a phenomenon known as “wash-out” occurs, and the displayed images cannot be clearly or easily observed.

Unlike the above-described types of displays, liquid crystal displays show images by utilizing a single artificial background light source, by utilizing ambient light, or by a combination of these means. Light from the background light source and/or ambient light passes through an array of tiny pixel regions of the liquid crystal display. Each pixel region individually controls the way that light beams pass through it, and the outgoing light beams of the pixel regions are collectively used to provide images for a display screen of the liquid crystal display. A liquid crystal display that only uses a single background light source is known as a transmission type liquid crystal display. A liquid crystal display that only utilizes ambient light is known as a reflection type liquid crystal display. A liquid crystal display that only uses both a background light source and ambient light is known as a transflective type liquid crystal display.

Of the three types of liquid crystal displays, the transmission type is particularly popular. The transmission type liquid crystal display employs the background light source (known as a “backlight”) behind a liquid crystal cell containing the pixel regions. Transmission type liquid crystal displays are advantageous due to their thinness and lightness, and have been used in numerous, diverse applications such as in notebook computers, mobile phones, etc. On the other hand, the backlight of a transmission type liquid crystal display consumes a relatively large amount of power. Thus even though only a small amount of power is needed to adjust light transmittances of liquid crystals in the pixel regions of the liquid crystal cell, a relatively large amount of power is consumed overall.

Transmission type liquid crystal displays wash out less frequently compared with the above-described light emissive type displays. In particular, in the case of color transmission type liquid crystal displays, the reflectance on the display surface of a color filter layer in the liquid crystal cell is reduced by reflectance reducing means such as a black matrix.

Nevertheless, it becomes difficult to readily observe images displayed on a color transmission type liquid crystal display when it is used under conditions where ambient light is very strong and the luminance of the display screen is relatively weak. This problem can be mitigated or even eliminated by using a brighter backlight. However, this solution further increases power consumption.

Unlike light emissive type displays and transmission type liquid crystal displays, reflection type liquid crystal displays show images by utilizing ambient light. Therefore the luminance of the display screen is proportional to the amount of ambient light. Thus reflection type liquid crystal displays are advantageous insofar as they do not wash out. Indeed, when a reflection type liquid crystal display is used in a very bright place (for example, in direct sunlight), the display can be observed all the more clearly. In addition, because a reflection type liquid crystal display does not use a backlight, it has the further advantage of low power consumption. For these reasons, reflection type liquid crystal displays are particularly suitable for devices used outdoors, such as in portable information terminals, digital cameras, and portable video cameras.

However, since reflection type liquid crystal displays utilize ambient light for displaying images, the luminance of the display screen depends on the surrounding environment. When ambient light is weak, the images on the display screen cannot be easily observed. In particular, in the case where a color filter is used for realizing color display for a reflection type liquid crystal display, the color filter absorbs part of the ambient light and the display screen becomes darker. Under these circumstances, the ambient light problem is even more pronounced.

Because of the above problems, the transflective type liquid crystal display was developed. The liquid crystal cell in a transflective type liquid crystal display allows part of light generated from a backlight to transmit therethrough for output of display light. The liquid crystal cell also allows ambient light to transmit therethrough. Part of the ambient light is reflected at a rear of the liquid crystal cell, and the reflected ambient light transmits through the liquid crystal cell for output of display light. Transflective type liquid crystal displays have been put into practical use in applications where the ambient light may be weak. In these applications, transflective type liquid crystal displays can maintain many of the advantages of reflection type liquid crystal displays.

Referring to FIG. 4 and FIG. 5, these show part of a conventional transflective LCD. The transflective LCD 100 has a first substrate 110, a second substrate 120, and a liquid crystal layer 130 sandwiched between the first and second substrates 110, 120. The first substrate 110 has a common electrode 111 and a color filter 112. The second substrate 120 has a plurality of gate lines 122, a plurality of data lines 121 crossing the plurality of gate lines 122, a plurality of thin film transistors (TFTs) 123, a plurality of reflective electrodes 141, and a plurality of pixel electrodes 124. Each TFT 123 is disposed at the intersection of a corresponding one of the data lines 121 and a corresponding one of the of gate lines 122. Three terminals of the TFT 123 electrically connect with the data line 121, the gate line 122, and the pixel electrode 124, respectively. The pixel electrode 124 corresponds to the common electrode 111. When a potential is applied across the two electrodes 124, 111, they form an electric field therebetween. The electric field controls twisting of liquid crystal molecules in the liquid crystal layer 130, such that light transmission through the liquid crystal layer 130 produces images for display.

The data lines 121 and gate lines 122 cross each other, thereby defining a plurality of pixel units 140. Each pixel unit 140 defines a transmission region T, and a reflective region R corresponding to the reflective electrode 141. The reflective region R surrounds the transmission region T. The reflective electrode 141 is made from a material with a high reflective ratio, and is disposed under the pixel electrode 124. The pixel electrode 124 is disposed at a same layer as the gate lines 122, and is connected with a corresponding one of the gate lines 122. Thus there is plurality of reflective electrodes 141 over the whole second substrate 120, with the reflective electrodes 141 being separate from each other. That is, each reflective electrode 141 needs to be electrically connected to the corresponding gate line 122. This makes the process of manufacturing the transflective LCD 100 unduly difficult.

Therefore, what is needed is a transflective LCD which can overcome the above-described problems.

### SUMMARY

An example transflective liquid crystal display includes a first substrate, a second substrate opposite to the first substrate; a liquid crystal layer sandwiched between the first and the second substrates; and a plurality of pixel units defined at the second substrate. Each pixel unit has a pixel electrode and a reflective electrode, and the reflective electrodes of at least two adjacent of the plurality of pixel units are electrically connected together.

Other objects, advantages and novel features will become more apparent from the following detailed description when taken in conjunction with the accompanying drawings. In the drawings, all the views are schematic.

### BRIEF DESCRIPTION OF THE DRAWINGS

FIG. 1 is a top plan view of a pixel unit and parts of surrounding pixel units thereof, all being part of a transflective LCD according to an exemplary embodiment of the present invention.

FIG. 2 is an enlarged, cross-sectional view of the same part of the transflective LCD according to the exemplary embodiment of the present invention, corresponding to line II-II of FIG. 1.

FIG. 3 is an enlarged, top plan view of a part of a color filter of the transflective LCD according to the exemplary embodiment of the present invention, such part located at two pixel units of the transflective LCD.

FIG. 4 is a top plan view of a pixel unit and parts of surrounding pixel units thereof, all being part of a conventional transflective LCD.

FIG. 5 is an enlarged, cross-sectional view of the same part of the conventional transflective LCD, corresponding to line V-V of FIG. 4.

### DETAILED DESCRIPTION OF THE PREFERRED EMBODIMENTS

Hereinafter, preferred embodiments of the present invention will be described in detail with reference to the accompanying drawings.

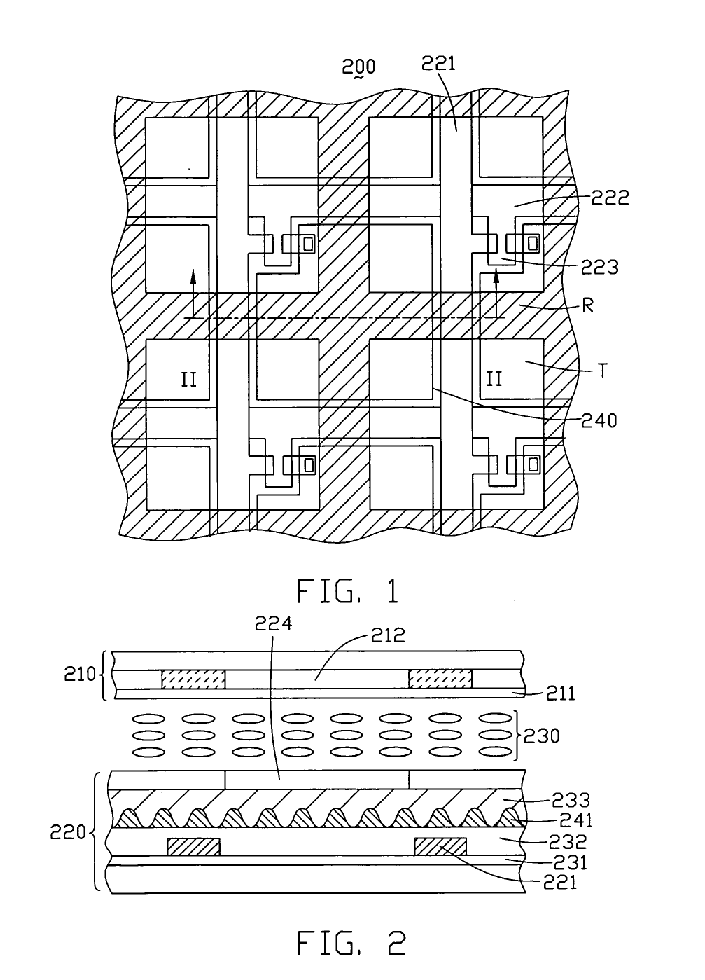

FIGS. 1 and 2 show parts of a transflective LCD according to an exemplary embodiment of the present invention. The transflective LCD 200 has a first substrate 210, a second substrate 220 opposite to the first substrate 210, and a liquid crystal layer 230 sandwiched between the first and second substrates 210, 220. The first substrate 210 has a color filter 212 and a common electrode 211 sequentially formed on an inner surface of a base plate (not labeled) thereof. The base plate is typically made of transparent glass.

The second substrate 220 has a plurality of data lines 221, a plurality of gate lines 222, a first insulation layer 231, a second insulation layer 232, a third insulation layer 233, a plurality of reflective electrodes 241, and a plurality of pixel electrodes 224. The gate lines 222, the first insulation layer 231, the data lines 221, the second insulation layer 232, the reflective electrodes 241, the third insulation layer 233, and the pixel electrodes 224 are formed on an inner surface of a base plate (not labeled) of the second substrate 220, in that order from bottom to top. The base plate is typically made of transparent glass. The plurality of data lines 221 and the plurality of gate lines 222 perpendicularly cross each other, thereby defining a plurality of pixel units 240. Each pixel unit 240 has a transmission region T, and a reflective region R corresponding to the reflective electrode 241. Each reflective electrode 241 is cross-shaped. The four points of the cross electrically connect with respective points of crosses of four adjacent reflective electrodes 241 of four adjacent pixel units 240. Thus, the reflective electrodes 241 of all the pixel units 240 are connected with one another to cooperatively form a crisscross pattern.

The second substrate 220 further has a plurality of TFTs 223 respectively disposed adjacent to intersections of the data lines 221 and gate lines 222. Each TFT 223 has three terminals, which respectively electrically connect to the corresponding data line 221, the corresponding gate line 222, and the corresponding pixel electrode 224. The TFT 223 receives signals from the gate line 222 and the data line 221 to control the potential of the pixel electrode 224. Thus, the pixel electrode 224 and the common electrode 211 cooperatively form an electrical field to control twisting of liquid crystal molecules in the liquid crystal layer 230.

The pixel electrode 224 is made from a transparent material, such as indium tin oxide (ITO). The reflective electrode 241 is made from metallic material having a high reflectivity. In addition, each reflective electrode 241 has a bumpy structure at an inner surface thereof facing toward the liquid crystal layer 230. Such structure enables the reflective electrode 241 to receive more ambient light beams over a larger range of incident angles, thereby improving a luminance of the transflective LCD 200.

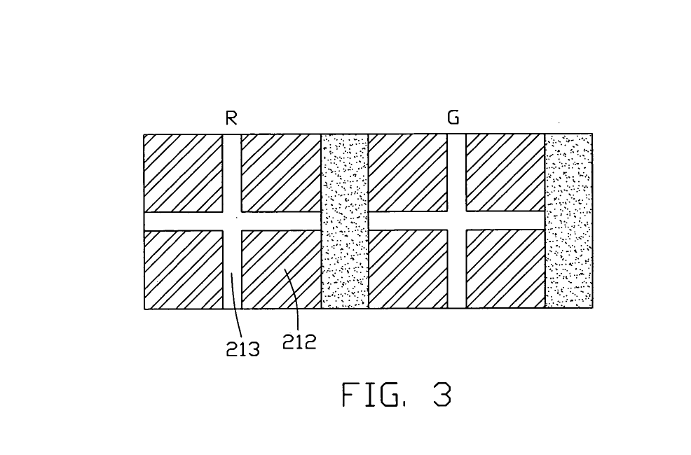

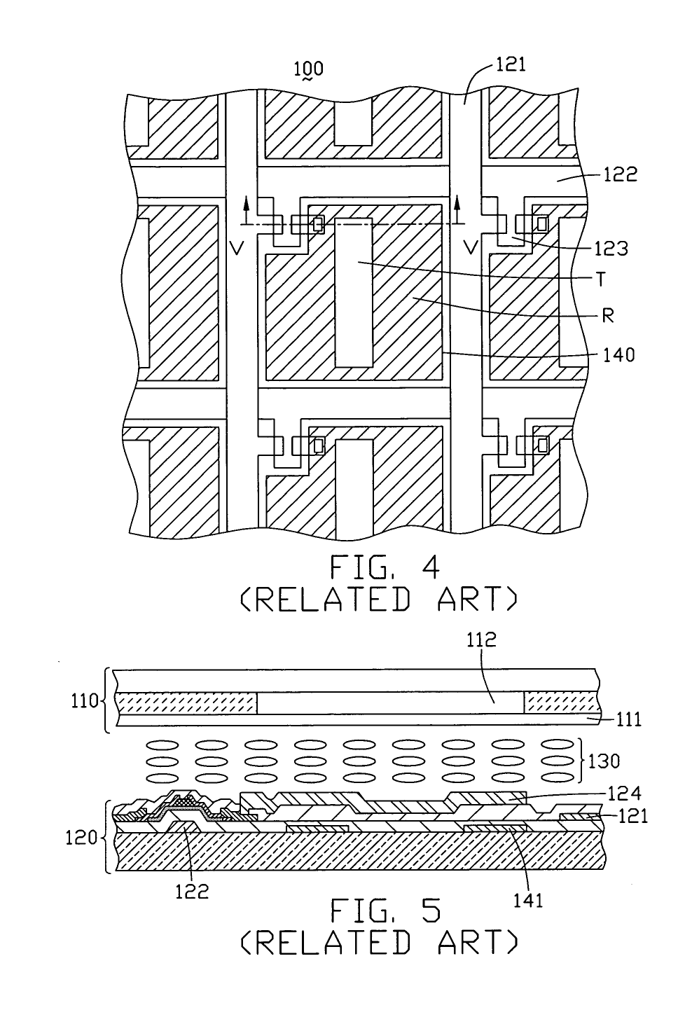

Referring to FIG. 3, a part of the color filter 212 at two pixel units 240 of the transflective LCD 200 is shown. At each pixel unit 240, a part of the color filter 212 corresponding in position to the reflective region R has a cross-shaped opening 213. An area of the opening 213 is less than that of the reflective region R. With this configuration, most of ambient light beams that are reflected by the reflective region R follow a path whereby they first transmit through the openings 213, are reflected by the reflective region R, and then transmit through one or another of the pigmented parts of the color filter 212. Such ambient light beams are thus output from the first substrate 210 for color display, after having passed through one or another of the pigmented parts of the color filter 212 once only. Further, some of backlight light beams that transmit into the second substrate 220 at the pixel unit 240 are blocked by the reflective region R. Other (a majority) of such backlight light beams transmit through the transmission region T, and then transmit through one or another of the pigmented parts of the color filter 212. Such backlight light beams are thus output from the first substrate 210 for color display, after having passed through one or another of the pigmented parts of the color filter 212 once only. Therefore the output ambient light beams and the output backlight light beams provide substantially the same level of brightness and color saturation for color display. That is, the brightness and color saturation of an image over a whole expanse of a display screen (not shown) of the transflective LCD 200 are substantially uniform.

The transflective LCD 200 features the electrical interconnecting between the reflective electrodes 241 over the whole of the second substrate 220, with the reflective electrodes 241 being formed over the data lines 221 in the second substrate 220. The electrically interconnected reflective electrodes 241 can have a same potential through a single connecting terminal at one side of the crisscross pattern, and there is no need to electrically connect each individual reflective electrode 241 to the respective gate line 222 of each pixel unit 240. This enables the process of manufacturing the transflective LCD 200 to be simplified.

In addition, the reflective electrodes 241 are not limited to being formed above the data lines 221. In alternative embodiments, the reflective electrodes 241 can be formed at a different layer to that shown in the exemplary embodiment. Further, the electrical interconnections of the reflective electrodes 241 need not necessarily include all the reflective electrodes 241 over the whole second substrate 220. Only selected of the reflective electrodes 241 may be connected together, according to need. For example, the reflective electrodes 241 can be defined as including a plurality of pairs of reflective electrodes 241, with electrical connection between adjacent reflective electrodes 241 only being provided between the reflective electrodes 241 in each pair of reflective electrodes 241.

It is to be further understood that even though numerous characteristics and advantages of various embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A transflective liquid crystal display, comprising:
a first substrate;
a second substrate opposite to the first substrate;
a liquid crystal layer sandwiched between the first and second substrates; and
a plurality of pixel units defined at the second substrate;
wherein each pixel unit comprises a pixel electrode and a reflective electrode, and the reflective electrodes of at least two adjacent of the plurality of pixel units are electrically connected together.

2. The transflective liquid crystal display as claimed in claim 1, wherein the reflective electrodes of all of the plurality of pixel units are electrically connected to each other.

3. The transflective liquid crystal display as claimed in claim 1, wherein each reflective electrode has a bumpy structure formed at an inner surface thereof facing toward the liquid crystal layer.

4. The transflective liquid crystal display as claimed in claim 1, wherein the first substrate has a color filter, and the color filter defines a plurality of openings corresponding to the reflective electrodes.

5. The transflective liquid crystal display as claimed in claim 4, wherein an area of each of the openings is smaller than that of an area of each of the reflective electrodes.

6. The transflective liquid crystal display as claimed in claim 1, wherein each reflective electrode is cross-shaped.

7. A transflective liquid crystal display, comprising:
a first substrate;
a second substrate opposite to the first substrate;
a liquid crystal layer sandwiched between the first and second substrates; and
a plurality of pixel units defined at the second substrate;
wherein each pixel unit comprises a pixel electrode and a reflective electrode portion, and the reflective electrode portions of at least two adjacent of the plurality of pixel units form a continuous single body.

8. The transflective liquid crystal display as claimed in claim 7, wherein the reflective electrode portions of all of the plurality of pixel units form the continuous single body.

9. The transflective liquid crystal display as claimed in claim 7, wherein each reflective electrode portion has a bumpy structure formed at an inner surface thereof facing toward the liquid crystal layer.

10. The transflective liquid crystal display as claimed in claim 7, wherein the first substrate has a color filter, and the color filter defines a plurality of openings corresponding to the reflective electrode portions.

11. The transflective liquid crystal display as claimed in claim 10, wherein an area of each of the openings is small than that of an area of each of the reflective electrode portions.

12. The transflective liquid crystal display as claimed in claim 10, wherein each reflective electrode portion is cross-shaped.

13. A liquid crystal display comprising:
a first substrate;
a second substrate opposite to the first substrate;
a liquid crystal layer sandwiched between the first and second substrates;
a plurality of data lines; and
a plurality of pixel units defined at the second substrate, each of said pixel units comprises a pixel electrode and a reflective electrode, wherein
the reflective electrode is located between the liquid crystal layer and the data lines.
